(19) United States
(12) Patent Application Publication
(10) Pub. No.: US 2017/0293860 A1
(43) Pub. Date: Oct. 12, 2017

(54) SYSTEM AND METHODS FOR SUGGESTING BENEFICIAL ACTIONS

(71) Applicant: Graham FYFFE, Los Angeles, CA (US)

(72) Inventor: Graham FYFFE, Los Angeles, CA (US)

(21) Appl. No.: 15/477,959

(22) Filed: Apr. 3, 2017

Related U.S. Application Data
(60) Provisional application No. 62/319,999, filed on Apr. 8, 2016.

(51) Int. Cl. G06N 99/00; G06N 5/04; G06F 17/30

(52) U.S. Cl. CPC G06N 99/005; G06F 17/30477; G06N 5/04

(57) ABSTRACT

A system and methods for suggesting beneficial actions may include generating a first predictive model to estimate a user profile, collecting user data pertinent to a user's circumstance or action at a point in time, collecting a database associating user profiles with sequences of user circumstances and user actions over time for one or more users, and generating a second predictive model to suggest an action or circumstance or a sequence of actions and circumstances to be communicated to a user based upon the estimated user profile and user data and the database of sequences of user circumstances and actions. The system delivers the suggested action or circumstance to a device carried by or worn by a user in the form of advice or a story, using text, speech, images, or video.

### CROSS-REFERENCE TO RELATED APPLICATIONS

The present application claims priority to U.S. Provisional Patent Application No. 62/319,999, entitled “Systems and Methods for Suggesting Beneficial Actions,” filed Apr. 8, 2016, the entirety of which is hereby incorporated by reference.

### BACKGROUND

### Field of the Invention

The invention pertains to a system and methods for suggesting beneficial actions.

### Related Art

Everyone wants a better life. People like stories that they can relate to, especially stories containing a challenge followed by a happy ending, because they can imagine part of their own life resembling part of the story, and they can apply actions or behavior in the story to their own life in the hopes of having their own happy ending. Self-help books contain anecdotes or stories of people presented with a challenge, and obtaining a good result after acting a certain way. Some stories are more blatant, where a character encounters a life coach, who explicitly guides them through the process of overcoming a challenge by acting a certain way, for example Will Smith in the Hollywood film “Hitched” or Ryan Gosling in “Crazy Stupid Love”. These stories can be inspirational; however, their utility is limited by several factors. Self-help books and life coach movies must deal in general terms in order to reach a broad audience, and as such, offer utility to an individual only by chance. Further, the individual would have to find and read or watch the book or film in order to receive the benefit. Giving specific advice tailored to an individual is one way to suggest a story that their life could resemble in the future, if they act on it. More affluent individuals can employ an actual life coach for a fee, but this is financially out of reach to the average person. There is great potential utility in an automated system that could provide advice to individuals on a large scale.

Many systems have been proposed in the art to gather information about a user, typically referred to as a user profile, in order to provide targeted content to a user. Targeted content is content with an agenda aimed towards a certain demographic, for example advertisements, where the goal is to interest users in purchasing a product or service. Many systems in the prior art employ user profiles for targeted content. For example, U.S.20090319329 builds a user profile for targeted content based on usage-related rules; U.S.20130211912 builds a user profile for targeted advertising; U.S.20060293957 builds a user profile based on web browser usage; U.S.20100131363 builds a profile based on media consumption for targeted advertising; and U.S.20100293052 builds a predictive model specifically for targeted advertising. All of these examples target users with the intention of achieving the goals of the producer of the content, regardless of the goals of the users. In contrast, a life coach would try to figure out what circumstances would benefit a user, and perhaps how the user may reach those circumstances. The prior art addresses neither of these points.

Other systems have been proposed in the art to recommend content to a user, based on comparing the content that a first user has reviewed to the content that other users have reviewed. For example, U.S.20080077574A1 recommends content to a user based on user access to message boards, social networking, RSS, or other content sites; U.S. Pat. No. 7,003,515 recommends songs or items to a user based on similarity to other songs or items that the user selects; and U.S. Pat. No. 8,095,432 recommends items to a user based on recommendations made by friends and non-friends in a social networking utility. These examples direct a user to consume potentially interesting content based on the user's habits or friends. In contrast, a life coach would direct a user towards actions that may lead to improved circumstances, which may even include changes to a user's habits.

Other systems have been proposed to recommend domain-specific activities to a user. For example, U.S. Pat. No. 8,235,724 recommends diet and fitness activities based on a user lifestyle profile, and makes adjustments to the recommendations based on actual user performance; and, U.S. Pat. No. 7,831,494 recommends adjustments to a user's financial portfolio based on a user profile. Although some aspects of these systems are coach-like, they are limited to rule-based recommendations from a database of activities in a predetermined domain, and cannot adapt to new or unexpected circumstances.

### SUMMARY

The following summary is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Embodiments of the invention provide an affordable solution to offer life-coach-like advice to help individuals achieve improved circumstances by learning sequences of activities and circumstances from many users on a large scale, and also offering advice tailored to the specific situation or circumstance of each individual.

In particular, a technological solution is provided to bring life-coach-like benefits to individuals, on a large scale reaching potentially millions of users, using machine learning and mobile computing devices. Embodiments of the invention are directed to a system that monitors a user's actions and circumstance, and suggests beneficial actions that the user could take, which may be in the form of advice or stories illustrating the action and expected benefits, and may be delivered to a device carried or worn by a user using text, speech, images, or video.

A system for suggesting beneficial actions acquires a machine representation of a user's actions and circumstance is disclosed. Data is collected by one or more devices carried by or associated with the user. A user may rate their happiness or self-actualization as a function of circumstance by providing feedback on present circumstances, or by filling out surveys or questionnaires, or by selecting or listing goals or circumstances they would consider beneficial. The system may prompt a user to state his or her intentions or describe his or her circumstances. A predictive model is constructed as a user profile, based on user ratings of circumstances, and by comparing the user's history of actions, circumstances, and ratings to a database of the same collected from other users, using machine learning algorithms. A machine learning technique such as reinforcement learning generates a second predictive model that predicts which action may lead to a future circumstance that maximizes or improves the user's self-actualization or happiness modeled according to the user profile. The reinforcement learning may be optimized jointly across multiple users. Geographic locations, businesses, individuals, or times and dates appearing in the predicted beneficial action may be substituted with other geographic locations, businesses, individuals, or times and dates. The system may preferentially substitute businesses or individuals that are registered in a database of preferred businesses or individuals. A fee may be collected for registration or for actual substitutions made.

A predicted beneficial action may be translated to human consumable form and communicated to a user in the form of advice or stories delivered using text, speech, images, or video. A mapping from the machine representation of action or circumstance to a human consumable form may be constructed using machine learning techniques, natural language processing, and data collected from devices associated with users, including user descriptions or statements of actions and circumstances, text, voice recordings, photographs, or video recordings. A mapping from the machine representation of action or circumstance to a human consumable form may be constructed partly based a set of rules for describing geographic locations, individuals, or points in time. The system may translate a sequence of actions or circumstances to a human consumable form in the form of a story represented in text, speech, images, or video. The system may restrict communications to times that are predicted not to inconvenience a user.

In accordance with one aspect of the invention, a system, method and computer readable medium are disclosed for suggesting beneficial actions. The system may include memory; one or more processors communicatively coupled to the memory; and one or more programs residing on the memory and executable by the one or more processors. The system method and computer are configured to receive user data from a user device; generate a first predictive model to estimate a user's self-actualization or happiness as a function of user data; generate a second predictive model to predict a sequence of future actions or circumstances to increase a user's self-actualization or happiness in accordance with the first predictive model; and deliver the sequence of future actions or circumstances to the user device.

The system, method and computer readable medium may further include the user device for collecting the user data.

The system, method and computer readable medium may further include the one or more programs are further configured to receive user data from one or more data providers.

The first predictive model may combine evidence of a first user's self-actualization or happiness with evidence of a second user's self-actualization or happiness based on the user data, wherein the first user is positively related to user data associated with the second user.

The system, method and computer readable medium may determine that the first user is positively related to user data associated with the second user is by a collaborative filtering algorithm executed by the one or more processors.

The predicted sequence of future actions or circumstances may be represented as a sequence of predicted future user data.

The second predictive model may be rule based. The second predictive model may be generated using a reinforcement learning algorithm executed by the one or more processors. The reinforcement learning algorithm may be Q learning or deep reinforcement learning.

The system, method and computer readable medium may further include substituting, within the predicted sequence of future actions or circumstances, references to a first location with references to a second location, in accordance with a set of interchangeability criteria and substitution criteria.

The system, method and computer readable medium may further include substituting, within the predicted sequence of future actions or circumstances, references to a first individual with references to a second individual, in accordance with a set of interchangeability criteria and substitution criteria.

The system, method and computer readable medium may further include translating the predicted sequence of future actions or circumstances from machine representation to a human consumable form. The human consumable form may include text, speech, images, or video. The human consumable form may at least partly be assembled from text, speech, images, or video extracted from the user data. The translation to human consumable form may be at least partly based on a set of rules. The system, method and computer readable medium may further include communicating the human consumable form to a user.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a diagram of a system in accordance with one embodiment of the invention.

FIG. 2 illustrates one aspect of a system, for modifying predicted beneficial actions or circumstances in accordance with one embodiment of the invention.

FIG. 3 illustrates one aspect of a system, for translating the machine representation of predicted beneficial actions or circumstances to human consumable form in accordance with one embodiment of the invention.

FIG. 4 shows a flowchart that illustrates the operation of one embodiment of the invention.

FIG. 5 is a diagram of the network architecture of a system in accordance with one embodiment of the invention.

FIG. 6 illustrates a computer connected to a network in accordance with one embodiment of the invention.

### DETAILED DESCRIPTION

Embodiments of the invention are directed to systems and methods for monitoring a user's actions and circumstances, and suggesting beneficial actions that the user could take, which may be in the form of advice or stories illustrating the action and expected benefits, and may be delivered to a device carried or worn by a user using text, speech, images, or video.

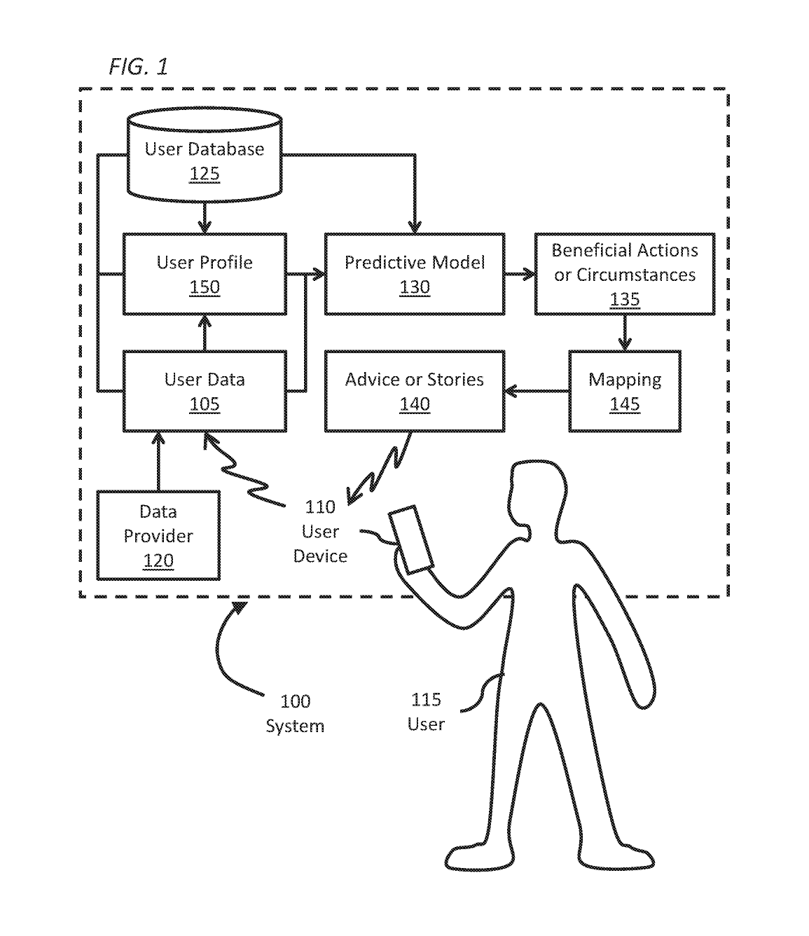

FIG. 1 shows a system 100 in accordance with one or more embodiments of the invention. As shown in FIG. 1, the system 100 interacts with users 115 that are configured to provide user data 105 using user devices 100.

The system 100 acquires a machine representation of user data 105, such as a user's actions and circumstance. In general, the user data 105 is a set of data collected by one or more user devices 110 carried by or associated with a user 115. In some embodiments, the user data 105 is provided by one or more data providers 120. The system 100 also may acquire the history of these data over time.

Examples of user devices 110 include a user's home computer, a user's vehicle, a wearable device worn by the user, or a user's mobile computing device such as a smart phone, laptop, tablet, or PDA. Data may be acquired from sensors associated with a user's device including cameras, microphones, speech recognition, GPS, smoke or air quality detectors, thermometers, heartrate monitors, blood sugar monitors, dopamine monitors, norepinephrine monitors, serotonin monitors, spectrometers, EEG or brain activity monitors, accelerometers, or pedometers. Data may also include feedback from a user, a user's web browsing history, a user's email history, a user's text messaging history, a user's reminder list or to do list, a user's purchasing history, a user's financial account history, a user's travel history including driving and walking, a user's employment history, a user's dining history, a user's entertainment viewing history, or a user's social media history.

Examples of data providers 120 include businesses that the user has interacted with such as banks, restaurants, travel agencies, or other businesses having computer network connectivity, or online services that the user has interacted with such as web search providers, online project management systems, social media websites or applications, online discussion groups, product or restaurant review websites, or the like.

The system 100 further includes a database 125 to store the user data 105 of the users 115. In some embodiments, the database 125 stores a historical record of the collected user data 105 over time.

The system 100 is configured to model a user's self-actualization or happiness as a function of circumstance using the user data 105. The system 100 correlates the user data 105 to understand the circumstances and actions that lead to user happiness or self-actualization. This predictive model is also referred to herein as a user profile 150. In some embodiments, the system predicts the user's rating using Collaborative Filtering machine learning algorithms, such as Matrix Factorization, Marginalized Denoising, and the like. Such algorithms typically predict user ratings for products or movies, and apply to the proposed system by substituting the machine representation of products or movie titles with a machine representation of user circumstance using the history of user data 105 as an input.

The user profile 150 may allow a user 115 to provide feedback to the system to rate their present circumstance, or may fill out surveys or questionnaires regarding a variety of circumstances, or may select or list goals or circumstances they would consider beneficial. The system 100 may also predict a user's rating for a circumstance by comparing the user's history of actions, circumstances, and ratings as user data 105 to the database 125 of the same collected from other users.

An objective of the system 100 is to maximize the rating that a user 115 would give to their future circumstance, as predicted by the user profile 150. With machine representations of the user data (user's actions and circumstance) 105, and objective function based on the user profile 150 in place, a second predictive model 130 is generated. The second predictive model 130 predicts which action or sequence of actions and circumstances 135 may lead to a future circumstance that maximizes or improves the user's self-actualization or happiness modeled according to the user profile 150. The system 100 may employ standard machine learning techniques such as Q Learning, Deep Reinforcement Learning, or other reinforcement learning methods to construct the second predictive model 130.

The system 100 may also examine data from multiple users 115, so that data 105 from multiple users may be employed to build predictive models 130 more rapidly, and also so that circumstances 135 jointly involving more than one user may be modeled, which may occur for example when two or more users interact with each other. In one embodiment, Multi Agent Reinforcement Learning is used to examine the data from multiple users 115. In one embodiment, when considering multiple users 115, a single predictive model 130 may be learned based on the concatenation of the user data (actions and circumstances) 105, and profiles 110 of all users involved, using a joint objective function that may be the sum, maximum, or minimum of the individual user objectives, or some combination thereof. The learned predictive model 130 may apply to any combination or permutation of users 115, so that symmetries in the data may be exploited across different users or sets of users.

While the use of Collaborative Filtering and Deep Reinforcement Learning may automatically discover and exploit symmetries in the data, it may be beneficial to bootstrap the system with some pre-programmed symmetries. Some geographical locations may be effectively interchangeable (for example, locations with similar businesses or similar annotations in a geographic database). Circumstances at a similar time-of-day may be interchangeable regardless of the day, circumstances occurring on a particular day of the week (Monday through Sunday) may be interchangeable regardless of the date, and circumstances occurring on special days (holidays) may be interchangeable regardless of the year. Circumstances involving individuals who are not users of the system may be interchangeable with those involving other individuals who are predicted to serve a similar role, for example based on a database of professionals or social networking information. These are only a few examples and are not hard rules.

The system 100 translates the machine representation of a predicted beneficial action or sequence of actions and circumstances 135 into human consumable form 140 so that it may be communicated to a user 115 in the form of advice or stories delivered using text, speech, images, or video, on a device 110 carried by, worn by, or associated with the user. In practice, distinguishing action from circumstance in the user data 105 may not be necessary, and the two concepts may be treated as one throughout the system. A mapping 145 from the machine representation of action or circumstance 135 to a human consumable form 140 may be constructed using machine learning techniques.

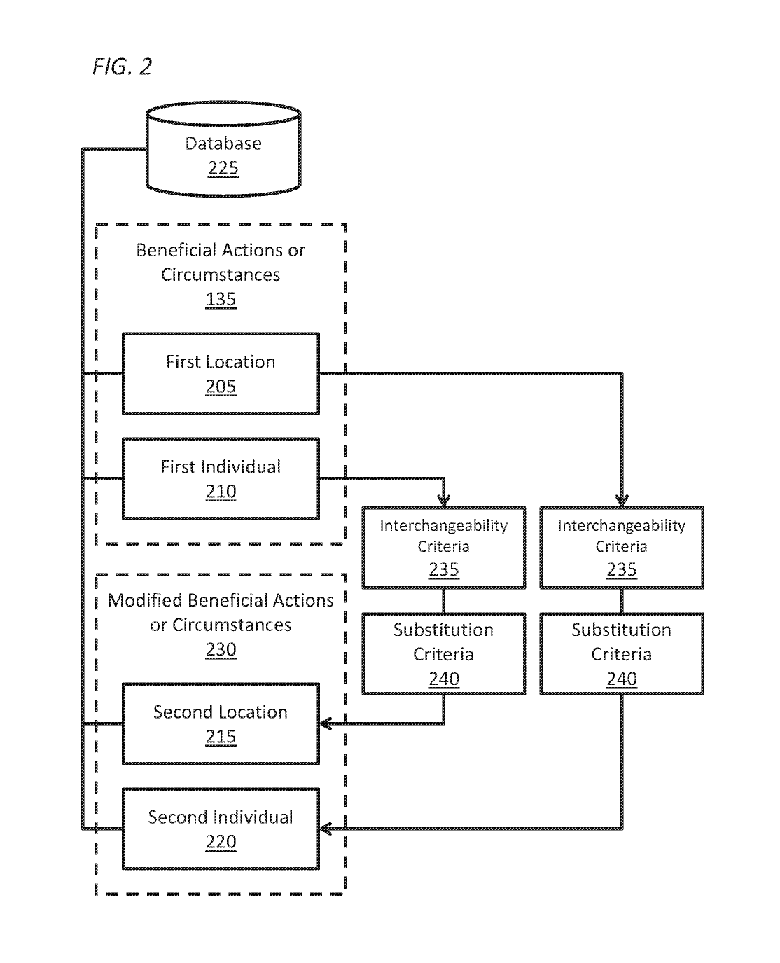

FIG. 2 illustrates one aspect of computing beneficial actions or circumstances based on the user data in accordance with embodiments of the invention. When computing beneficial actions or circumstances 135 involving a first location 205 or a first individual 210, the system 100 may substitute a second location 215 interchangeable with the first location 205 or a second individual 220 interchangeable with the first individual 210, based on a database 225 of locations or individuals, producing modified beneficial actions or circumstances 230, in accordance with a set of interchangeability criteria 235 and substitution criteria 240.

Interchangeability may be determined by a number of interchangeability criteria 235, for example, where a first location of business 205 or first individual 210 offers a similar service as a second location of business 215 or second individual 220, or where a first location 205 or first individual 210 is geographically close to a second location 215 or second individual 220, or where user data 105 recorded when a first user 115 was at or near a first location 205 or first individual 210 is at least partly similar to user data 105 recorded when a second user 115 was at or near a second location 215 or second individual 220.

Substitution may be determined by one or more substitution criteria 240, for example, locations or individuals geographically near to a user 115 may be preferentially substituted over locations or individuals geographically farther from the user; locations or individuals that a user 115 has been at or near, as determined by user data 105, may be preferentially substituted over locations that the user has not been at or near. In some embodiments, a small fee may be collected from business owners or individuals who elect to have their location or information registered in the database 225, so that registered locations or individuals are preferentially substituted over those that are not registered, and where the fee collected may be based on registration or based on actual substitutions made. Other substitution criteria, relating a first location 205 to a second location 215 or a first individual 210 to a second individual 220, may also determine a substitution. The system 100 may substitute a first item for a second item more relevant to a user 115, for example, a first time or date in the past may be substituted with a second time or date in the near future; a first object may be substituted with a similar second object appearing in a text document or photograph in the user data 105; a first activity may be substituted with a similar second activity mentioned in a text document, web browsing history, or voice recording in the user data 105; or generally a first item may be substituted with a similar second item where there is evidence in the user data 105 that the user 115 may be aware of the second item or may prefer the second item.

The system 100 translates the machine representation of a predicted beneficial action or sequence of actions and circumstances 135 or modified beneficial action or sequence of actions and circumstances 230 into human consumable form 140 so that it may be communicated to a user 115 in the form of advice or stories delivered using text, speech, images, or video, on a device 110 carried by, worn by, or associated with the user. In practice, distinguishing action from circumstance in the user data 105 may not be necessary, and the two concepts may be treated as one throughout the system. A mapping 145 from the machine representation of action or circumstance 135 or modified beneficial action or sequence of actions and circumstances 230 to a human consumable form 140 may be constructed using machine learning techniques.

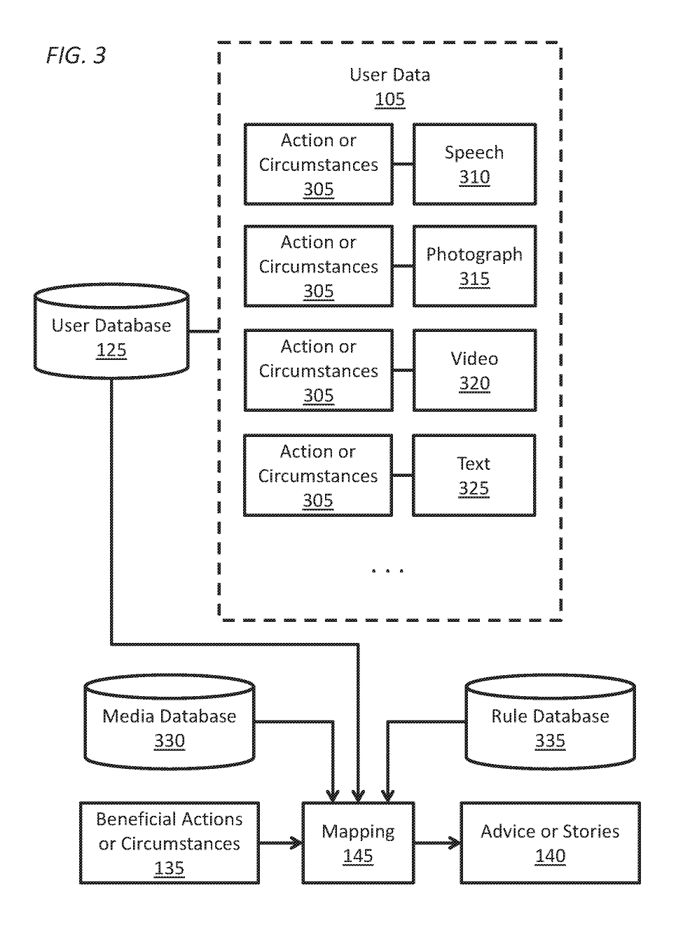

FIG. 3 illustrates the mapping 145 in further detail according to embodiments of the invention. In one embodiment, the text, speech, images, or video 140 communicated to a user 115 may be the direct output of a Reinforcement Learning technique; however, directly learning the output required to maximize the objective in this way may be prohibitively slow or beyond the capability of the learning algorithm. Thus, in one embodiment, the communication 140 to the user 115 may be synthesized using text synthesis, speech synthesis, image synthesis, or video synthesis, and for example may be parameterized in terms of piecing together segments from a media database 330 of speech, images, videos, or text relating to a wide variety of topics, which may be supplemented using voice recordings 310, photographs 315, video recordings 320, or text 325 from a user's device or otherwise associated with a user. The user voice recordings 310, photographs 315, video recordings 320, or text 325 may be associated with a user action or circumstances 305 when such data is available. For example, in one embodiment, the system 100 may prompt or encourage a user 115 to state his or her intentions as speech 310 or text 325, or describe his or her circumstances using speech 310, photographs 315, video 320 or text 325, and the system may employ speech recognition, natural language understanding, or text recognition to determine the words spoken by the user or other individuals nearby, or words appearing in photographs or videos. These records of user intention or circumstance may be collected in the user database 125, associated with the user action and circumstance 305. The collected records or words derived therefrom may be later incorporated into the advice or stories 140 for the same user or for other users via the mapping 145 when the computed beneficial actions or circumstances 135 resemble the action or circumstances 305 associated with the speech 310, photographs 315, video 320 or text 325 in the user database 105.

The system 100 may be programmed to map some actions or circumstances 135 to human consumable form 140 using a set of rules from a rule database 335, for example if the suggested circumstance 135 contains a geographic location then the system may ask the user to go to that location, or if the suggested action 135 includes interacting with an individual then the system may ask the user to contact the individual, or if a suggested action 135 pertains to a particular point in time then the system may ask the user to do the action at that point in time. The system 100 may communicate a single action or a sequence of actions or circumstances to a user as advice or stories 140. In the case of a sequence, the Reinforcement Learning component predicts a sequence of circumstances or actions that lead to future circumstances or actions that the user considers beneficial, as modeled by the user profile 150. Rather than communicating the complete sequence, the system 100 may construct a summary consisting of only the key steps in the sequence, determined by those circumstances or actions that appear more often in beneficial predicted sequences than in non-beneficial predicted sequences, or by other forms of Subgoal Discovery. Such a summary may be communicated to the user in the form of a story, represented in text, speech, images, or video 140.

The system 100 may restrict communications to times when it is estimated that a user 115 would not be inconvenienced by the communication, when the user is not speaking, or when nobody is speaking to the user, or when the user is awake but idle, or when the user requests advice from the system. Such conditions may be detected using one or more sensors on a device carried by or worn by the user, for example, using a microphone to detect when the user is not speaking, or when nobody is speaking to the user, or using motion sensors and location sensors to detect when a user is likely to be awake but idle.

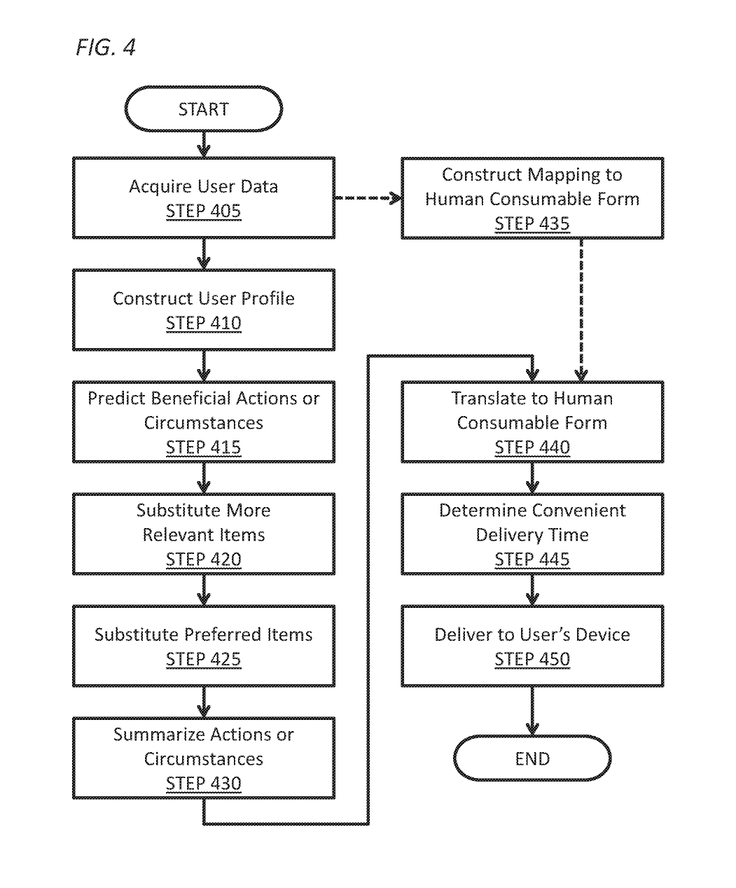

FIG. 4 shows a flowchart in accordance with one or more embodiments of the invention. It is understood by those skilled in the art that some steps are optional, and some steps may be performed in a different sequence, without departing from the scope of the invention. In STEP 405, user data 105 is acquired and stored in a user database 125. In STEP 410, a user profile 150 is constructed, based on the user data 105 and the user database 125. In STEP 415, a beneficial action or circumstance or beneficial sequence of actions or circumstances 135 is predicted using a predictive model 130 and the user data 105. In STEP 420, items such as locations, individuals, times, or dates occurring in the predicted beneficial actions or circumstances 135 may be substituted with other items that are more relevant to a user 115, producing modified beneficial actions or circumstances 230. The substitution may be performed according to a set of interchangeability criteria 235 and a set of substitution criteria 240. In STEP 425, some items may be substituted with other preferred items that are registered with a database 225, where a business or individual pays a fee to list items in the database 225 or pays a fee according to actual substitutions made. In STEP 430, beneficial sequences of actions or circumstances 135 may be summarized as a shorter sequence of key actions or circumstances. In STEP 435, a mapping 145 from the machine representation of actions or circumstances, such as those appearing in user data 105 or in predicted beneficial actions or circumstances 135, is constructed using machine learning techniques and the user data 105 and user database 125. STEP 435 may be executed concurrently with other steps. In STEP 440, the machine representation of the predicted beneficial actions or circumstances 135, modified beneficial actions or circumstances 230, or a summary thereof is translated to human consumable form such as advice or stories 140 using the mapping 145. In STEP 445, a delivery time is chosen that is predicted not to inconvenience a user 115, based on sensors on a device 110 carried by or worn by the user, such as when the user is not speaking or being spoken to, or when the user is awake but idle. In STEP 450, the advice or stories 140 are delivered to a device 110 carried by or worn by a user 115 in the form of text, speech, images, or video.

In some embodiments, the system generates the first predictive model (user profile) 150 and second predictive model 130 to determine the actions and circumstances to recommend to a user numerous times during the day. In some embodiments, the system generates the models 150, 130 at least once every half hour; however, it will be appreciated that it may be beneficial to perform generate the models 150, 130 once every 5-10 minutes. It will be appreciated that the frequency that the models are generated and that beneficial actions are determined may be more frequently than every 5 minutes or may be less frequently than every half hour. It will also be appreciated that the receipt of user data (or particular types of user data) may automatically trigger the generation of the models 150, 130 to determine the recommended actions. Similarly, the system 100 may determine that certain user activity has occurred based on the user data 105, and then generates the predictive model 130 to recommend a beneficial user action or circumstance. Furthermore, a user query or use of a user interface associated with the system 100 may trigger the generation of the models 150, 130.

FIG. 5 depicts the network architecture of a system in accordance with one embodiment of the invention. One or more server computers 505, one or more data providers 120 and one or more user devices 110 are connected to a computer network 510 such as the Internet. A user database 125 may reside on a server 505. A database 225 of locations or individuals may reside on a server 505. In one embodiment, a media database 330 and rule database 335 employed in the mapping 145 may reside on a server 505. In another embodiment, a media database 330 and rule database 335 employed in the mapping 145 may reside partially on a user device 110 and partially on a server 505.

In one embodiment, a server computer 505 is configured to execute instructions to: receive user data 105 from one or more user devices 110 or data providers 120; store user data 105 in a user database 125; construct a user profile 150 based on the user data 105 and the user database 125; construct a predictive model 130 for predicting a beneficial action or circumstance or beneficial sequence of actions or circumstances 135 based on the user data 105 and user profile 150; execute the predictive model 130 to predict a beneficial action or circumstance or beneficial sequence of actions or circumstances 135 based on user data 105 and user profile 150; substitute items such as locations, individuals, times, or dates occurring in the predicted beneficial actions or circumstances 135 with other items that are more relevant to a user 115 according to a set of interchangeability criteria 235 and a set of substitution criteria 240 to produce modified beneficial actions or circumstances 230; preferentially substitute items such as locations or individuals occurring in the predicted beneficial actions or circumstances 135 with other preferred items that are registered with a database 225; store a record of actual substitutions made in the predicted beneficial actions or circumstances 135 for later processing of fees to be collected; summarize beneficial sequences of actions or circumstances 135 as a shorter sequence of key actions or circumstances; construct a mapping 145 from the machine representation of actions or circumstances, such as those appearing in user data 105 or in predicted beneficial actions or circumstances 135, using machine learning techniques and the user data 105 and user database 125; translate the machine representation of the predicted beneficial actions or circumstances 135, modified beneficial actions or circumstances 230, or a summary thereof to human consumable form such as advice or stories 140 using the mapping 145; receive sensor data from a device 110 carried by or worn by the user, to predict when the user is not speaking or being spoken to, or when the user is awake but idle; choose a delivery time that is predicted not to inconvenience a user 115, using the sensor data received from a device 110 to predict when the user is not speaking or being spoken to, or when the user is awake but idle; and deliver advice or stories 140 to a device 110 carried by or worn by a user 115 in the form of text, speech, images, or video. User data 105 may be transmitted from a user device 110 or data provider 120 to a server 505 via the computer network 510. Advice or stories 140 may be transmitted from a server 505 to a user device 110 via the computer network 510. It is understood by those skilled in the art that some steps are optional, and some steps may be performed in a different sequence, without departing from the scope of the invention. In another embodiment, a user device 110 may be configured to execute instructions to perform some of the steps listed herein. A computer readable medium may store instructions for performing the steps listed herein.

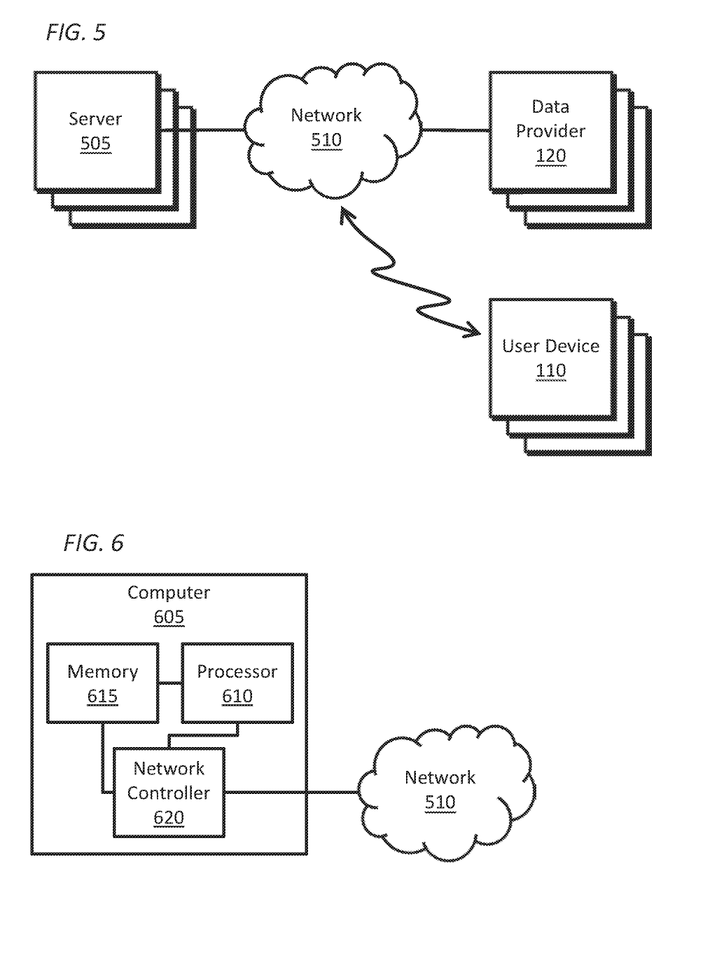

FIG. 6 depicts a computer 605 connected to a network 510. A server 505, user device 110, or data provider device 120 may be a computer 605 connected to a network 510, configured with one or more processors 610, a memory 615, and one or more network controllers 620. It is understood that the components of the computer 605 are configured and connected in such a way as to be operational, so that an operating system and application programs may reside in the memory 615 and may be executed by the processor or processors 610 and data may be transmitted or received via the network controller 620 according to instructions executed by the processor or processors 610. Those skilled in the art will appreciate that the one or more processors 610, memory 615, or network controllers 620 may physically reside on multiple physical components within the computer 605, or may be integrated into fewer physical components within the computer 605, without departing from the scope of the invention. In one embodiment, a plurality of computers 605 may be configured to execute some or all of the steps listed herein, such that the cumulative steps executed by the plurality of computers are in accordance with the invention.

One or more of the methodologies or functions described herein may be embodied in a computer-readable medium on which is stored one or more sets of instructions (e.g., software). The software may reside, completely or at least partially, within memory and/or within a processor during execution thereof. The software may further be transmitted or received over a network.

It should be understood that components described herein include computer hardware and/or executable software code which is stored on a computer-readable medium for execution on appropriate computing hardware.

The terms “computer-readable medium” or “machine readable medium” should be taken to include a single medium or multiple media that store the one or more sets of instructions. The terms “computer-readable medium” or “machine readable medium” shall also be taken to include any non-transitory storage medium that is capable of storing, encoding or carrying a set of instructions for execution by a machine and that cause a machine to perform any one or more of the methodologies described herein. The terms “computer-readable medium” or “machine readable medium” shall accordingly be taken to include, but not be limited to, solid-state memories, and optical and magnetic media. For example, “computer-readable medium” or “machine readable medium” may include Compact Disc Read-Only Memory (CD-ROMs), Read-Only Memory (ROMs), Random Access Memory (RAM), and/or Erasable Programmable Read-Only Memory (EPROM). In other embodiments, some of these operations might be performed by specific hardware components that contain hardwired logic. Those operations might alternatively be performed by any combination of programmable computer components and fixed hardware circuit components.

In one embodiment, a plurality of computers 605 are configured to execute some or all of the steps listed herein in service of a plurality of users 115. In one embodiment, a plurality of computers 605 access a common user database 125 and a common predictive model 130 in service of a plurality of users 115. In one embodiment, a user database 125 stores user data records 105 for a plurality of users 115 and associates records 105 with corresponding users 115 via a user ID. Those skilled in the art will appreciate that a user database 125, database 225 of locations or individuals, media database 330, or rule database 335 may reside on a single server computer 505 or may be distributed or duplicated across a plurality of server computers 505, without departing from the scope of the invention.

All machine learning aspects of the system may be bootstrapped using information from experts or from self-help literature, for example by feeding the system 100 with artificial user data 105 crafted in accordance with the information from experts or from self-help literature. This bootstrapping may be especially important in constructing the mapping 145 from suggested actions into human consumable form.

The system may have utility to the users beyond what prior art can offer. For example, the system may infer that users fitting a certain financial pattern achieved a higher self-actualization or happiness rating after recording voiced statements related to refinancing a home, and thus the system may synthesize suggestions regarding refinancing a home to other users who fit a similar financial pattern, even if those users had not thought of doing so themselves. Similarly, the system may detect patterns of users recording statements or making social media posts related to asking their employer for a raise, and based on the user's financial history and other user data factors the system may infer that some users benefit from this action while others do not, and the system may synthesize suggestions accordingly. In another example, the system may detect a pattern that users recently visiting a specific geographic location experienced increases in happiness ratings, which may indicate for example a new social club or a great new restaurant, and so the system may synthesize suggestions to other users that they should visit this geographic location. Other types of patterns that may be detected and suggested include detecting good times and places for bringing children out to play, inferring which baby sitters or plumbers or other professionals are most effective at increasing user happiness, detecting a good new employer in a user's area, detecting a good geographic location to move to, or inferring certain food items to shop for to improve health and happiness, any of which may be suggested by the system even if the user had not been thinking about the topic. These examples may all be amenable to automatic inference using machine learning based on the user associated data and data history.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

It should be understood that processes and techniques described herein are not inherently related to any particular apparatus and may be implemented by any suitable combination of components. Further, various types of general purpose devices may be used in accordance with the teachings described herein. The present invention has been described in relation to particular examples, which are intended in all respects to be illustrative rather than restrictive. Those skilled in the art will appreciate that many different combinations will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

1. A system for suggesting beneficial actions, comprising:
memory;
one or more processors communicatively coupled to the memory; and
one or more programs residing on the memory and executable by the one or more processors, the one or more programs configured to:
receive user data from a user device;
generate a first predictive model to estimate a user's self-actualization or happiness as a function of user data;
generate a second predictive model to predict a sequence of future actions or circumstances to increase a user's self-actualization or happiness in accordance with the first predictive model; and
deliver the sequence of future actions or circumstances to the user device.

2. The system as in claim 1, further comprising collecting the user data from a plurality of user devices.

3. The system as in claim 1, wherein the one or more programs are further configured to receive user data from one or more data providers.

4. The system as in claim 1, wherein the first predictive model combines evidence of a first user's self-actualization or happiness with evidence of a second user's self-actualization or happiness based on the user data, wherein the first user is positively related to user data associated with the second user.

5. The system of claim 4, wherein the determination that the first user is positively related to user data associated with the second user is by a collaborative filtering algorithm executed by the one or more processors.

6. The system as in claim 1, wherein the predicted sequence of future actions or circumstances is represented as a sequence of predicted future user data.

7. The system as in claim 1, wherein the second predictive model is rule based.

8. The system as in claim 1, wherein the second predictive model is generated using a reinforcement learning algorithm executed by the one or more processors.

9. The system as in claim 8, wherein the reinforcement learning algorithm comprises Q learning or deep reinforcement learning.

10. The system as in claim 1, wherein the one or more programs are further configured to execute the second predictive model to predict a sequence of future actions or circumstances to increase or maximize a user's self-actualization or happiness in accordance with the first predictive model.

11. The system as in claim 10, wherein the one or more programs are further configured to substitute, within the predicted sequence of future actions or circumstances, references to a first location with references to a second location, in accordance with a set of interchangeability criteria and substitution criteria.

12. The system as in claim 10, wherein the one or more programs are further configured to substitute, within the predicted sequence of future actions or circumstances, references to a first individual with references to a second individual, in accordance with a set of interchangeability criteria and substitution criteria.

13. The system as in claim 10, wherein the one or more programs are further configured to translate the predicted sequence of future actions or circumstances from machine representation to a human consumable form.

14. The system as in claim 13, wherein the human consumable form comprises text, speech, images, or video.

15. The system as in claim 14, wherein the human consumable form is at least partly assembled from text, speech, images, or video extracted from the user data.

16. The system as in claim 14, wherein the translation to human consumable form is at least partly based on a set of rules.

17. The system as in claim 13, wherein the one or more programs are further configured to communicate the human consumable form to a user.

18. A method for suggesting beneficial actions, comprising the steps of:
receiving user data from a user device;
generating, using a processor, a first predictive model to estimate a user's self-actualization or happiness as a function of user data, based on evidence of a user's self-actualization or happiness within the user data;
generating, using a processor, a second predictive model to predict a sequence of future actions or circumstances to increase or maximize a user's self-actualization or happiness in accordance with the first predictive model;
executing, using a processor, the second predictive model to predict a sequence of future actions or circumstances to increase or maximize a user's self-actualization or happiness in accordance with the first predictive model;
translating the predicted sequence of future actions or circumstances from machine representation to a human consumable form; and
communicating the human consumable form to a user.

19. The method of claim 18, further comprising: receiving user data from one or more data providers.

20. The method of claim 18, wherein the first predictive model combines evidence of a first user's self-actualization or happiness with evidence of a second user's self-actualization or happiness when user data associated with the first user is positively related to user data associated with the second user.

21. The method of claim 20, further comprising executing a collaborative filtering algorithm to determine the first user is positively related to user data associated with the second user.

22. The method of claim 18, wherein the predicted sequence of future actions or circumstances is represented as a sequence of predicted future user data.

23. The method of claim 18, wherein the second predictive model is rule based.

24. The method of claim 18, wherein the second predictive model is generated using a reinforcement learning algorithm, such as Q learning or deep reinforcement learning.

25. The method of claim 18, further comprising: substituting, within the predicted sequence of future actions or circumstances, references to a first location with references to a second location, in accordance with a set of interchangeability criteria and substitution criteria.

26. The method of claim 18, further comprising: substituting, within the predicted sequence of future actions or circumstances, references to a first individual with references to a second individual, in accordance with a set of interchangeability criteria and substitution criteria.

27. The method of claim 18, wherein the human consumable form comprises text, speech, images, or video.

28. The method of claim 27, wherein the human consumable form is at least partly assembled from text, speech, images, or video extracted from the user data.

29. The method of claim 27, wherein the translation to human consumable form is at least partly based on a set of rules.

30. A computer readable storage medium storing program instructions to suggest beneficial actions, the instructions comprising functionality to:
receive user data from a user device;
generate a first predictive model to estimate a user's self-actualization or happiness as a function of user data, based on evidence of a user's self-actualization or happiness within the user data; and
generate a second predictive model to predict a sequence of future actions or circumstances to increase or maximize a user's self-actualization or happiness in accordance with the first predictive model.

31. The computer readable storage medium of claim 30, the instructions further comprising functionality to receive user data from one or more data providers.

32. The computer readable storage medium of claim 30, wherein the first predictive model combines evidence of a first user's self-actualization or happiness with evidence of a second user's self-actualization or happiness when user data associated with the first user is positively related to user data associated with the second user.

33. The computer readable storage medium of claim 32, further comprising executing a collaborative filtering algorithm to positively relate the first user to the second user.

34. The computer readable storage medium of claim 30, wherein the predicted sequence of future actions or circumstances is represented as a sequence of predicted future user data.

35. The computer readable storage medium of claim 30, wherein the second predictive model is rule based.

36. The computer readable storage medium of claim 30, wherein the second predictive model is generated using a reinforcement learning algorithm, such as Q learning or deep reinforcement learning, executed by the one or more processors.

37. The computer readable storage medium of claim 30, the instructions further comprising functionality to execute the second predictive model to predict a sequence of future actions or circumstances to increase or maximize a user's self-actualization or happiness in accordance with the first predictive model.

38. The computer readable storage medium of claim 37, the instructions further comprising functionality to substitute, within the predicted sequence of future actions or circumstances, references to a first location with references to a second location, in accordance with a set of interchangeability criteria and substitution criteria.

39. The computer readable storage medium of claim 37, the instructions further comprising functionality to substitute, within the predicted sequence of future actions or circumstances, references to a first individual with references to a second individual, in accordance with a set of interchangeability criteria and substitution criteria.

40. The computer readable storage medium of claim 37, the instructions further comprising functionality to translate the predicted sequence of future actions or circumstances from machine representation to a human consumable form.

41. The computer readable storage medium of claim 40, wherein the human consumable form comprises text, speech, images, or video.

42. The computer readable storage medium of claim 41, wherein the human consumable form is at least partly assembled from text, speech, images, or video extracted from the user data.

43. The computer readable storage medium of claim 41, wherein the translation to human consumable form is at least partly based on a set of rules.

44. The computer readable storage medium of claim 40, the instructions further comprising functionality to communicate the human consumable form to a user.
